(19) United States
(12) Patent Application Publication
(10) Pub. No.: US 2021/0329935 A1
(43) Pub. Date: Oct. 28, 2021

(54) Methods and Systems for Processing Non-Dairy Cheese

(71) Applicant: Good Seed Creamery LLC, Fernandina Beach, FL (US)

(72) Inventor: Meghan Barbera, Fernandina, FL (US)

(21) Appl. No.: 17/240,329

(22) Filed: Apr. 26, 2021

Related U.S. Application Data
(60) Provisional application No. 63/016,249, filed on Apr. 27, 2020.

(51) Int. Cl. A23C 20/02; A23C 20/00; A01J 25/02; A01J 25/15; A23P 30/20

(52) U.S. Cl. CPC A23C 20/025; A23C 20/005; A23P 30/20; A01J 25/15; A01J 25/02

(57) ABSTRACT

The present disclosure provides an exemplary method for producing non-dairy cheese. In some embodiments, this novel process of making non-dairy cheese may be similar to the manufacturing of traditional dairy cheese. In some aspects, the seeds used in this process may be used for the production of other products that may or may not be related to the non-dairy cheese production. In some embodiments, different cultures may be added to the non-dairy cheese to give it different textures, chemical balances, tastes, and other attributes, as non-limiting examples. In some implementations, throughout the process, the pH and moisture levels may be monitored, which may ensure the mixture reaches target levels at each step of the process. In some aspects, other criteria based on weight of cheese, amount of culture added, and other non-limiting factors may impact the production of the non-dairy cheese.

### CROSS REFERENCE TO RELATED APPLICATION

This application claims priority to and the full benefit of U.S. Provisional Patent Application Ser. No. 63/016,249, filed Apr. 27, 2020, and titled “METHODS AND SYSTEMS FOR PROCESSING NON-DAIRY CHEESE”, the entire contents of which are incorporated in this application by reference.

### BACKGROUND

Cheese has been enjoyed for thousand of years, when humanity started herding animals. While there is no exact record of when cheese was first created, some believe cheese may have been created by accident when milk was stored in a pouch made from a sheep's stomach that mixed with an enzyme present in stomach lining. Rennet, an enzyme found in a stomach of ruminant animals, would cause milk to coagulate, separating into curds in whey. Some believe cheese was discovered after milk was salted, causing the milk to curdle for preservation purposes. Another theory regarding the origin of cheese is that fruit juices were added to milk, which caused the milk to curdle as a result of the acid in the fruit juice.

Eventually, goat or sheep's milk was then consciously used for cheese, shown in evidence left by the Sumerian and early Egyptian societies. Cheesemaking is referred to in ancient Greek mythology. Curdled milk, and later cheese, was a way to further preserve a perishable necessity. Current popular cheeses, like Cheddar, Swiss, Parmesan, and Gouda, were created within the last 500 years.

The Romans were one of the first societies to mass produce cheese, where some homes had separate rooms for storing and creating cheese. During this time, Romans sought to extend the life of their cheese, leading them to age or smoke their cheese. Cheese was used as a useful source of proteins for their armies, which spread the ubiquity of cheese through Europe. In medieval times, monasteries that made beer and wine also made cheese.

In the United States, cheesemaking remained a local farm industry until the 19^{th} century, when the first cheese factory was built in Oneida County, N.Y. By the mid-19^{th} century, Swiss immigrants settled in Green County, Wis. and started manufacturing foreign cheese within America. This led to the creation of the wholesale cheese industry, with dairy factories producing up to 216 million pounds of cheese by 1880. Currently, approximately one-third of all milk produced each year in the United States is used to manufacture cheese. Continued demand for milk is due to this continued growth of the cheese industry.

Since cheese is a staple in many diets, alternative options have emerged over time to fit those needs, such as for vegans, those who are lactose intolerant, or those otherwise allergic to milk or soy. These cheese alternatives may be used as culinary replacements for cheese and may contain a significant amount of non-dairy protein, such as soybeans, nuts, or seeds. These cheese alternatives may or may not contain the protein usually found in milk, casein or caseinates, that usually causes cheese to melt and stretch. There are imitation cheeses and cheese substitutes that may or may not replicate the expected qualities of cheese.

As a result, food scientists have been trying to replicate properties that consumers might expect from cheese: that it melts, is spreadable, and can become creamy. Other areas that are being replicated are the smell, look, and texture. For some cheese alternatives, this requires experimentation with the right amount of gums, protein, solids, and fats that go into the cheese alternative to reproduce the feeling of eating traditional cheese. Some cheese alternatives experiment with other ingredients like water, oil, starches, flavorings, and colorings, as well as protein bases like soy or rice, to try to reproduce casein, which is the protein that helps hold a cheese together. One of the goals of experimenting with these mixtures is to prevent cheese alternatives from separating into their component parts instead of blending together to form something cheese-like.

Food scientists continue to experiment with cheese alternatives using a variety of non-dairy alternatives as a starting point. In less industrial settings, cheesemakers can use culture liquid made from sprouted grains such as quinoa or wheatberries, sauerkraut juice, or probiotic capsules intended for digestion health as non-limiting examples of a starting point. For each variation, there is a need to get the consistency right for a consumer as well as a way to make sure the cheese alternative can scale for mass production.

### SUMMARY OF THE DISCLOSURE

What is needed is a method and system for processing non-dairy cheese at a consistency resembling traditional, dairy cheese that may be scaled for mass production. In some embodiments, the method and system may be used on an individual basis for at-home use. In some implementations, the method and system may be used to produce non-dairy cheese variations at volume based on the equipment available. In some aspects, the method and system may be used to produce non-dairy cheese at a reliable consistency to reproduce the creaminess of dairy cheese. In some embodiments, the method and system may use alternative non-dairy ingredients, such as almonds, cashews, macadamia nuts, hemp seeds, soy, non-dairy milk, apple cider vinegar, water, mustard, cayenne, Sriracha, as non-limiting examples, to produce non-dairy cheese or plant-based cheeses. In some implementations, the method and system may produce allergen-free non-dairy cheese. In some aspects, the method and system may be less environmentally taxing than other production alternatives.

In some embodiments, the method and system may provide a process for the preparation of non-dairy cheese from coagulated and cultured proteins. In some implementations, the method and system may use heat to coagulate proteins. In some aspects, the method and system may use a variety of procedures to produce, replicate, or recreate traditional cheese flavor. In some embodiments, non-dairy cheese may be curdled to recreate a traditional dairy cheese. In some implementations, the method and system may separate curds from non-dairy whey using alternative dairy products to produce traditional cheese flavors.

In some embodiments, hemp-based cheese may be made with acid coagulants, such as lactic acid, tartaric acid, glucono delta lactone, or vinegar. In some aspects, a form of vegetable rennet, plant-based enzymes, or tofu coagulant, such as calcium sulfate or magnesium chloride with calcium chloride, may be used. In some implementations, additives may be used for binding, such as guar, xantham gum, tapioca starch, or citrus fiber, as non-limiting examples.

In some aspects, the non-dairy production may use seeds or nuts to help the production of the cheese. In some embodiments, the seeds or nuts may be blended with a liquid; water or milk, to start the process of the non-dairy cheese making. In some implementations, the present disclosure relates to the production of non-dairy cheese utilizing hemp seed milk.

In some embodiments, the pulpy milk may be run through a centrifuge that separates the two entities so that the pulp can be discarded, and the milk can be continued through the process. In some embodiments, the pulp may be recycled, used for unrelated products or donated for other processes that may need the recycled pulp, however, these may not be the only limiting examples. In some aspects, a centrifuge may be combined with a decanter to separate and remove pulp. In some embodiments, the milk may transfer to a cheese vat so that the cheese may be heated and curdle.

In some implementations, the curdling process may require the milk to be set at specific temperatures and the curds to be specific sizes for the process to continue. In some embodiments, the curdling process may be reoccurring if the curds do not meet the required specifications. In some implementations, once the cheese has curdled then the culture may be added to the cheese. In some aspects, the culture may contain different ingredients based on desired textures or tastes. In some embodiments, the culture can comprise microbes typically used in cheese making. In some aspects, the microbes may include Lactobacillus sps., Lactococcus lactis sps., Streptococcus thermophilus, Leuconostoc mesenteidess sps., as a non-limiting list of examples. In some aspects, proprietary blends may be made from a wide variety of microbes to achieve flavors and cheese types.

In some implementations, additives may be integrated to adjust the texture, such as by adding magnesium chloride to soften the cheese. In some aspects, small amounts of sugar can be added to increase fermentation of cultures. In some embodiments, the texture may be limited by the ability to coagulate the protein of the base seed or nut milk.

In some embodiments, the non-dairy whey may be drained from the curds so that the cheese is significantly lighter than when the process started. In some aspects, once the curds have been drained, the culture may be added and mixed together before the fermentation process starts. In some implementations, the fermentation process may start after the culture has been added. In some embodiments, once the cheese has been fermented and drained, seasoning may be added to the mixture. In some aspects, different seasonings may be added to different mixtures.

In some embodiments, the cheese may be pressed, packaged, and sold once the seasoning is added and the cheese has been tested for quality assurance. In some embodiments the temperature, moisture, and other levels may be monitored throughout the process to ensure the end product meets predefined parameters. In some embodiments, if the levels fall out of acceptable range throughout the process, the system may adjust to correct the levels, the system may be manually adjusted, or a batch may be treated until the levels are adjusted, as non-limiting examples.

In some implementations, the present disclosure relates to a method for processing non-dairy cheese. In some aspects, the method includes adding water to a seed-based milk; heating the seed-based milk to a predefined curdling temperature, curdling the seed-based milk, cooling the seed-based milk to a predefined cooling temperature, creating a mixture by adding at least one culture to the seed-based milk, fermenting the mixture at a predefined fermenting temperature, draining non-dairy whey from the mixture, and removing a cheese from the mixture.

In some embodiments, the seed-based milk may comprise a manufactured milk. In some implementations, the method may comprise creating the seed-based milk. In some aspects, the at least one culture may comprise a plurality of culture types. In some embodiments, curdling may occur until curdles may comprise a predefined size. In some implementations, the seed-based milk may be based on a hemp seed. In some aspects, the at least one culture may comprise Lactobacillus sp. Fermenting occurs until a predefined pH level may be reached. In some embodiments, non-dairy whey may be drained until the mixture reaches a predefined moisture level.

In some implementations, non-dairy whey may be removed until the cheese reaches a predefined percentage reduction in weight. In some embodiments, the predefined percentage reduction in weight may comprise at least 30%. In some implementations, the method may comprise adding at least one culture to allow for fermenting. In some aspects, the at least one culture may comprise a mesophilic bacteria. In some embodiments, the predefined cooling temperature may comprise 40° C. or less. In some implementations, the seed-based milk utilizes whole seeds. In some aspects, the seed-based milk may be utilizes hearts of seeds. In some embodiments, the method may further comprise creating the seed-based milk further may comprise blending seeds and water; and straining pulp from the seed-based milk. In some implementations, the pulp may be used for other products.

In some aspects, the present disclosure relates to a system for processing non-dairy cheese. In some embodiments, the system includes a blender configured to receive and blend seeds and water, where blended seeds and water initiates seed-based milk with pulp; a centrifuge configured to separate pulp from the seed-based; and a cheese vat configured to receive the seed-based milk, where the seed-based milk may be convertible into cheese within the cheese vat; and an extruder configured to portion cheese and press into a predefined shape. In some implementations, the seeds may comprise hemp seeds.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates exemplary manufacturing steps for producing non-dairy cheese, according to some embodiments of the present disclosure.

FIG. 2 illustrates exemplary manufacturing steps for producing non-dairy milk, according to some embodiments of the present disclosure.

FIG. 3 illustrates exemplary manufacturing steps for producing non-dairy milk, according to some embodiments of the present disclosure.

FIG. 4 illustrates an exemplary centrifuge for producing non-dairy milk, according to some embodiments of the present disclosure.

FIG. 5 illustrates exemplary manufacturing steps for producing non-dairy cheese, according to some embodiments of the present disclosure.

FIG. 6 illustrates exemplary method steps for producing non-dairy cheese, according to some embodiments of the present disclosure.

FIG. 7 illustrates exemplary method steps for producing non-dairy cheese, according to some embodiments of the present disclosure.

FIG. 8 illustrates an exemplary flow chart for producing non-dairy cheese, according to some embodiments of the present disclosure.

FIG. 9 illustrates exemplary stages for producing non-dairy cheese, according to some embodiments of the present disclosure.

FIG. 10 illustrates an exemplary flow chart for producing non-dairy cheese, according to some embodiments of the present disclosure.

FIG. 11 illustrates an exemplary flow chart for producing non-dairy cheese, according to some embodiments of the present disclosure.

FIG. 12 illustrates an exemplary flow chart for producing non-dairy cheese, according to some embodiments of the present disclosure.

FIG. 13 illustrates an exemplary flow chart for producing non-dairy cheese, according to some embodiments of the present disclosure.

### DETAILED DESCRIPTION

The present disclosure relates to a method of producing non-dairy cheese that utilizes processes typically associated with manufacturing dairy cheeses. The ability to use high temperature processing allows for the production of non-dairy cheese with a longer shelf-life and a consistency that more closely resemble dairy cheeses. In some aspects, the present disclosure relates to the production of non-dairy cheese utilizing hemp seed milk.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Cheese: as used herein refers to food made from pressed curds of non-dairy milk.
Milk: as used herein refers to liquid compositions extracting nutrients and flavors from seeds and nuts.
Curd: as used herein refers to a soft substance formed when milk sours or when proteins coagulate via heat or acid.
Pulp: as used herein refers to shells, hulls, fibers resulting in unwanted texture, flavor, or color.

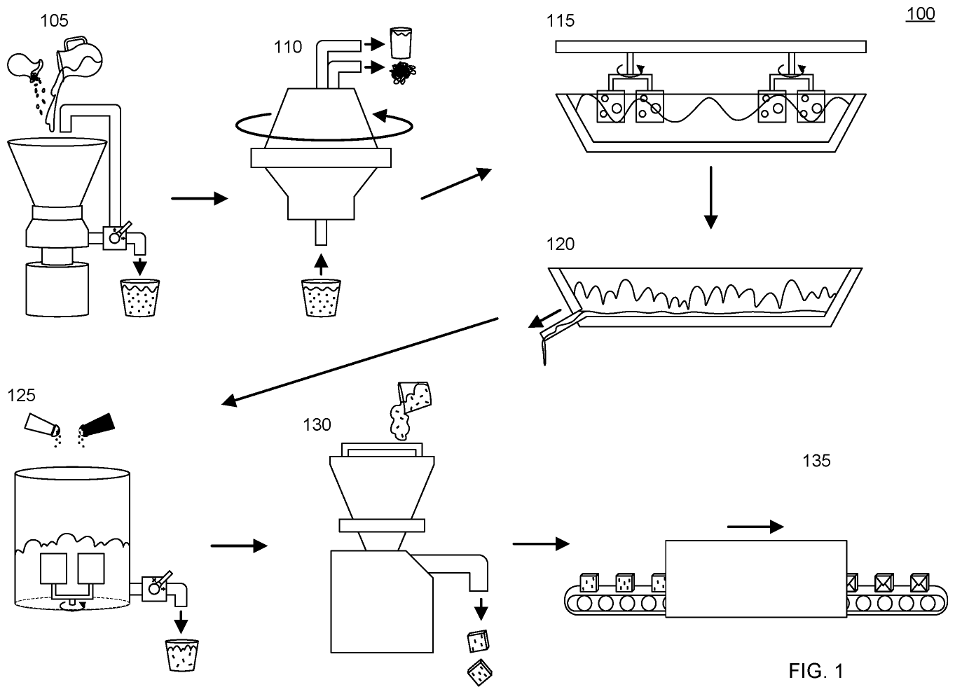

Referring now to FIG. 1, an exemplary method for the manufacturing process of the cheese 100 is illustrated. In some aspects, water may be blended in a blender 105 with seeds, which may start the seed milk with the pulp. In some embodiments, the seeds may be whole seeds. In some implementations, the water may be blended with hemp hearts to start the milk. In some aspects, milk production may be continuous. For example, the combination of water and seeds may be regulated automatically and continually produce large volumes of milk in industrial-sized containers. In some implementations, the seed to water ratio may comprise around 2.5-3.5 pounds of seed to around 1 gallon of water. After filtration, remaining solids may comprise between 20% and 30%.

In some embodiments, a centrifuge 110 may separate the pulp from milk so that the pulp may be properly removed. In some implementations, the centrifuge may comprise a vibratory screener to retain a portion of the pulp. In some aspects, the pulp may be used for other products such as, but not limited, to feed for animals, paper, or tissue. Once the pulp is effectively removed from the liquid, the milk may be transferred to a cheese vat 115, which may be used to curdle the cheese, integrate add culture, and ferment the cheese 100. Once the cheese 100 passes through the cheese vat 115 then non-dairy whey 120 may be drained from that mixture into a separate container or holding area.

In some embodiments, seasoning may be added to the cheese mixture 125. In some implementations, the seasoning may comprise a salt, which may continue to remove moisture from the curds. In some embodiments, adding salt may limit the unintended growth of microorganisms. In some aspects, different seasonings may be used for different types of cheeses. For example, a different type of seasoning may be used for Monterey jack than the type of seasoning used for pepper jack cheese. Different seasonings may allow for a range of flavors for a cream cheese or chevre. Once the seasoning has been added 125, the product may be placed into an extruder 130, and the cheese may be portioned and pressed into a predefined shape. The portioned cheese may continue on a conveyor belt and packaged 135. In some aspects, the cheese may be aerated and homogenized, such as to create a cream cheese texture.

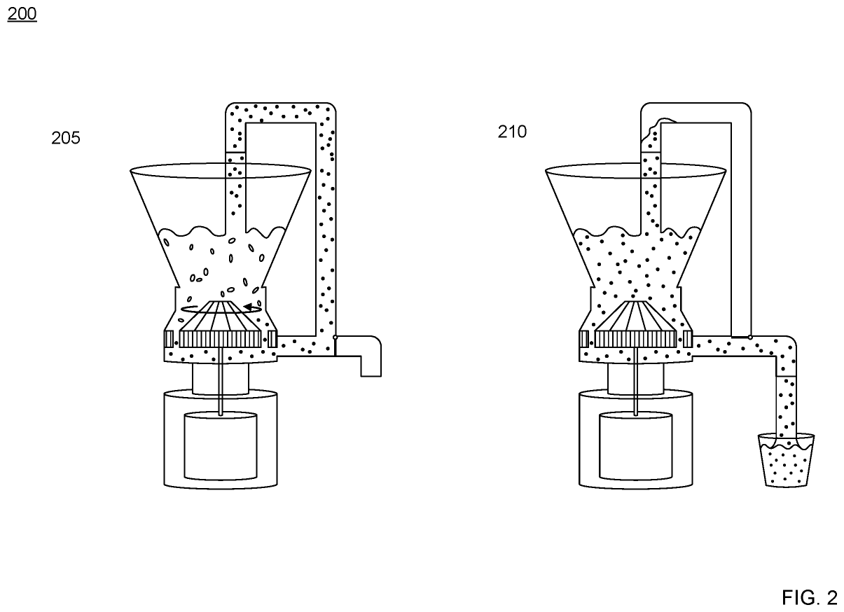

Referring now to FIG. 2, exemplary manufacturing steps for producing non-dairy milk are illustrated. In some aspects, the seeds may need to be blended 200 with a liquid to start the process. In some embodiments, the seeds may be whole seeds. In some implementations, hearts of the seed may be used to start the process. In some aspects, the liquid may typically be water. In some embodiments, the liquid may comprise dairy milk, fruit juice, oil or any other non-limiting example. In some aspects, a colloidal mill may be used to blend the seeds 200 as shown in the figure. In some implementations, this may be a cyclical process until the seeds are small enough and the fat and fiber from the seeds are emulsified in suspension with the water.

In some embodiments, the colloidal mill may comprise a sensory system that may determine how much blending the machine needs to execute. For example, sensors may be installed on the interior of machine to sense the sizing of the seeds being blended 205. In some aspects, the sensors may take a sample size of more than one seed while they are rotating throughout the machine. In some embodiments, the sensor may stop the machine to sweep the entirety of the product to ensure that all the seeds are under a specific size requirement to distribute the product and seeds. In some embodiments, the seeds may need to be under a specifically required size to ensure that the sensor passes the product through to the next stage. For example, the seeds and product may not pass through the mill until the sensor ensures the seeds are small enough, and the mill may continue blending the seeds 200 until they pass the size requirements.

In some implementations, once the seeds have been acceptably blended, pulpy milk 210 may be dispensed. In some aspects, the pulpy milk 210 production may be continuous. In some embodiments, the production of pulpy milk 210 may be autonomously regulated.

In some embodiments, the pulpy milk 210 may be used for different products connected to the cheese or used separately for other categorized products. In some implementations, the pulpy milk 210 may be dispensed into a large container and transported all at once. In some implementations, the pulpy milk 210 may be dispensed into portioned cups or containers.

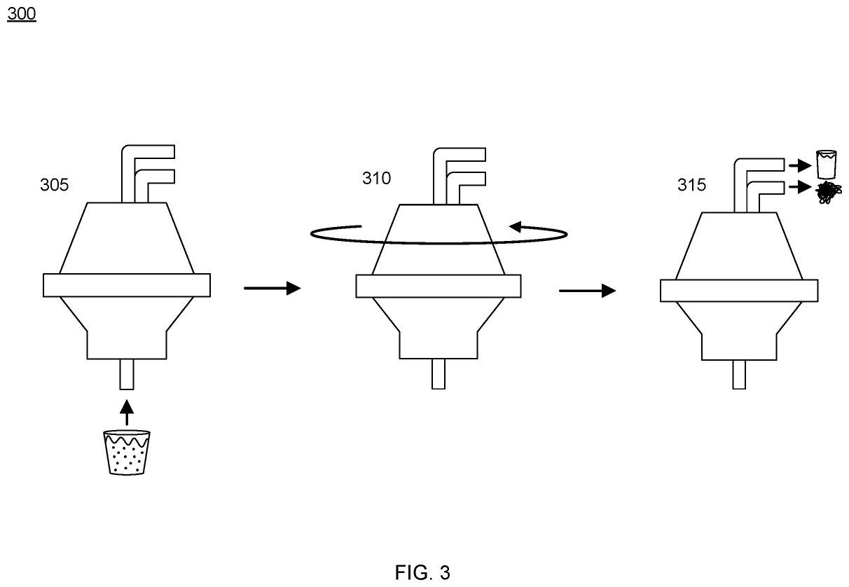

Referring now to FIG. 3, exemplary manufacturing steps 300 for producing non-dairy milk are illustrated. In some aspects, the process may begin with the centrifuge receiving the milk with pulp 305. In some embodiments, the pulpy milk may be manually dispensed into the centrifuge. For example, an employee or worker may pour the portioned cups or container full of pulpy milk into the centrifuge. In some aspects, the pulpy milk may be transported to a dispenser that feeds the pulpy milk into the centrifuge automatically.

Once the centrifuge contains pulpy milk, the centrifuge may spin to separate the pulp from the liquid 310. In some embodiments, the centrifuge may have a sensory system, similar to that of the mill previously described. For example, the centrifuge may sense when the centrifuge is full, which may trigger the spinning process. In some aspects, the centrifuge may not have a dedicated direction in which the it needs to spin for the process to work. For example, the centrifuge may alternate between clockwise and counterclockwise to prevent wear on the machine in one direction. In some implementations, the spinning cycle may have a set time in which it runs to determine when the liquid and pulp have been separated. In some embodiments, the centrifuge may comprise a sensory system which helps determine when the process is complete.

Once separated, the pulp and the milk 315 may be dispensed. In some aspects, the pulp may be dispensed or used for other products. In some embodiments, the milk may directly transfer to the cheese processing steps. In some aspects, the centrifuge may comprise separate dispensing pipes that allow for the separate dispensing of the pulp and the milk 315. In some embodiments, once the products have been dispensed to their respective areas, the centrifuge may clean itself using an autocleaning system. In some implementations, the centrifuge may be cleaned manually by an employee or separate user.

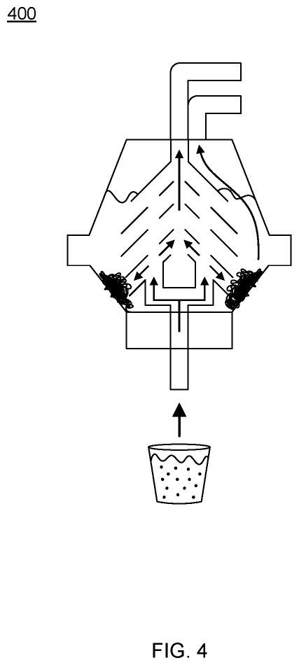

Referring now to FIG. 4, an exemplary centrifuge 400 for producing non-dairy milk is illustrated. In some aspects, the milk may move upward through the centrifuge and out of the top of the device. In some embodiments, as the milk moves through the centrifuge the pulp may be collected on the sides of the device as shown in the figure. For example, the centrifuge may allow the liquid milk to move up through the device, and the pulp may deposit on the outside of the device because a filter may exist in the device preventing the pulp from exiting with the milk. In some implementations, the centrifuge may spin in one direction allowing for centrifugal force to keep the deposits of pulp from reentering the stream of the milk.

In some aspects, the pulp collection may be manually cleaned out after each cycle or the machine may have an autocleaning system that helps remove pulp from the system. In some embodiments, the skim milk may flow out of the top of the centrifuge while cream may collect in the middle of the device. For example, thinner milk (skim milk) may exit the top of the device and be used separately than the cream portion. In some implementations, the milk may be recombined for the cheese-making process. In some aspects, the cream and skim portions of the milk may be used for separate products, such as different cheeses. In some embodiments, the cross section of the centrifuge may help the milk be pushed up and out of the device as shown in the figure.

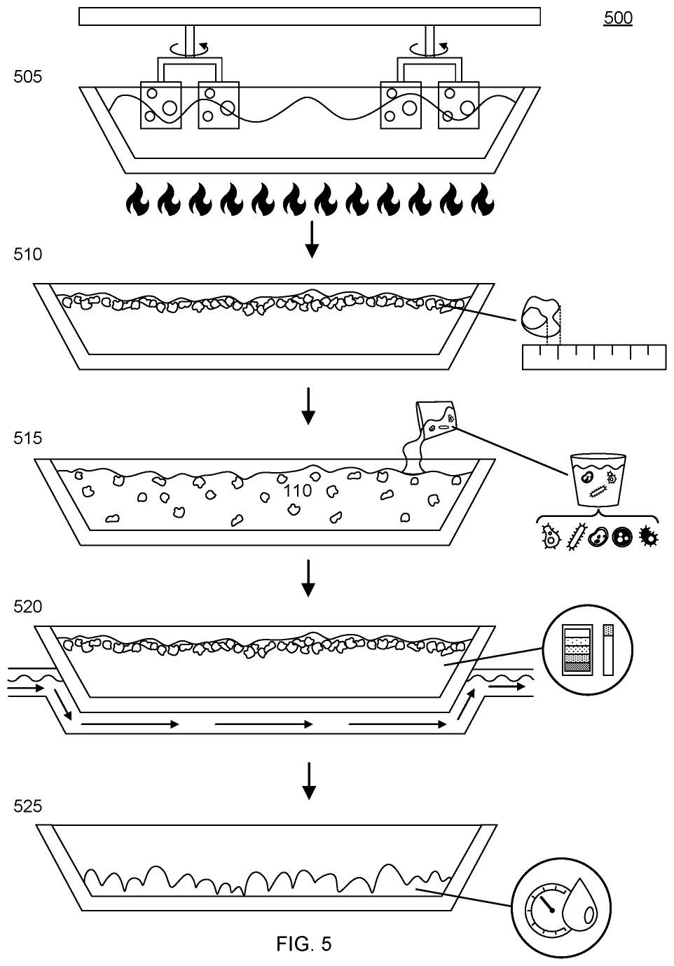

Referring now to FIG. 5, exemplary manufacturing steps for producing non-dairy cheese are illustrated. In some implementations, a cheese vat 505 may be used to collect the filtered milk so that it may curdle and ferment into curds and acidified whey. In some aspects, the cheese vat 505 may comprise a stirring and cutting system that may rotate through the fermented milk throughout the process. In some implementations, this system may help keep the milk consistent and evenly cut throughout the process.

In some embodiments, after the milk has been poured into the cheese vat 505, the milk may be heated and stirred. As an illustrative example, the milk may be heated to between eighty and eighty-five degrees Celsius for thirty seconds while the machine is continuously stirring. In some aspects, the milk may be heated until the water visibly separates from the curd. For example, the milk may be heated to 180-185 degrees before the water visibly separates. The milk may then be cooled. In some embodiments, a longer cooking time may result in a grainier, coarser cheese.

In some implementations, this cooling step 510 may allow for the proteins to coagulate and form a curd, pasteurizing the milk. In some aspects, this step may benefit from monitoring of curd size, which may ensure the step continues until the curd comprises predefined parameters before proceeding to the next step. For example, the curds may need to be between 0.5 centimeters and 2.3 centimeters. In some aspects, curds may be between 1 mm to 5 mm.

In some embodiments, the curds may be measured manually to ensure that each curd meets the requirements. For example, a random sampling of curd may be pulled from the mixture and measured. In some embodiments, the machine may ensure that all curds are between the required size using the cutting and stirring system implemented on the machine. For example, the cutters may be sized between the required size of the curds before installed on the machine to ensure that the curds are never below or above the requirements.

In some embodiments, once all the curds have been measured to the size specifications, culture 515 may be added to the product. In some embodiments, different cultures may be selected for fermentation based on the desired end product. In some aspects, culture may be selected based on cheese type, texture, desired taste, acidity, desired shelf-life, or shipping parameters, as non-limiting examples.

As illustrative examples, hard cheese may be made with Streptococcus thermophilus, Lactobacillus delbrueckii subsp. bulgaricus, Lactobacillus helveticus, and Lactobacillus lactis. Molds such as penicillium candidum (white mold) and penicillium roqueforti (blue mold) may be added to the fermentation process to create molded cheeses, similar to blue cheese or camembert. This may allow for the rind to bloom as well as allow for marbling throughout the cheese. In some aspects, Bifidobacterium lactis may be used.

In some implementations, before the culture may be added, the curdled mixture may be cooled, such as to forty-one degrees Celsius, for the culture to mix effectively with the mixture. In some embodiments, when the culture is added to the mixture, the mixture may be rehydrated during incubation. In some implementations, the culture may need to be measured per gallon of milk for proper rehydration. For example, one unit of culture may need to be added per ten gallons of milk. In some implementations, the culture and mixture may need to incubate for an allotted amount of time. For example, the incubation period may require four hours to properly set before the process can continue.

In some aspects, the one or more cultures may require predetermined levels of temperature. As an illustrative example, mesophilic cultures may require the culture to be added when the milk is below 30° C. between 21°-25° C. The mesophilic culture may require a longer period of 12-24 hours.

After the culture has been added, the fermentation 520 period may then take place. In some embodiments, the pH levels may need to be monitored to ensure the fermentation process is working correctly. For example, the target acidity may comprise a 5.5 pH level. In some implementations, a lower pH level may reduce microorganism growth, such as 4.7 or lower, ideally between 4.3 and 4.7. In some aspects, the fermentation process may require a specific time and temperature for the process to occur correctly. For example, the inoculated milk may need to ferment for four hours at forty-one degrees Celsius to properly ferment.

In some implementations, cool water may be pumped in proximity to the inoculated milk to cool the vat to the predefined temperature. In some aspects, the inoculated milk may need to be cooled below forty degrees Celsius for mesophilic cultures. In some embodiments, the inoculated milk may be transferred to a separate container or apparatus for fermentation. In some embodiments, the fermentation process may occur in the cheese vat similar to the previous steps.

In some implementations, once the inoculated milk has finished fermenting then the mixture may be drained 525. In some aspects, a cheesecloth and draining basket may be used to drain the non-dairy whey from its previous state. In some embodiments, the draining process may occur for up to twenty-four hours before the next process can begin. In some aspects, the moisture may continuously be monitored during the draining process. For example, the moisture may be manually checked periodically, or there may be a sensory system that may update the moisture data throughout the draining process. In some aspects, the system or user may be notified if the moisture level is not within a predefined range, and steps may be taken to adjust the level.

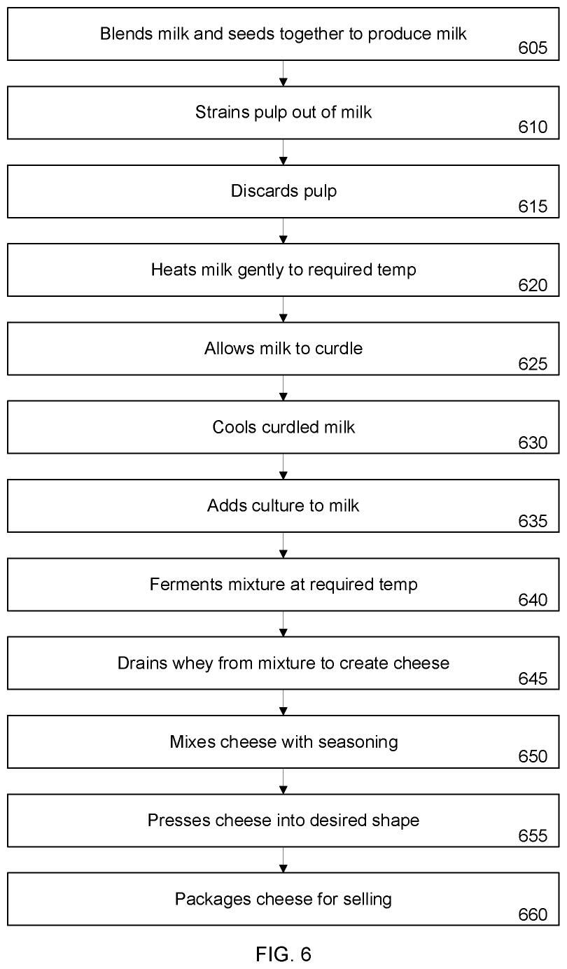

Referring now to FIG. 6, exemplary method steps for producing non-dairy cheese are illustrated. In some embodiments, at 605, the milk and seeds may be blended together to produce the pulpy milk needed to start the process. Once the pulpy milk has been properly blended, at 610, the pulp may be strained from the milk. In some implementations, the seed or nut selection may be based on the process or desired cheese product. For example, hemp milk may comprise enough protein to create a firm curd, which may allow for a firmer cheese, and hemp milk may comprise enough fat to create a rich texture.

At 615, the pulp may be discarded or removed, and in some aspects, the pulp may then be used for different products. Once the milk has been separated, at 620, the milk may be gently heated to the required temperature. In some embodiments, the temperature may be manually or automatically monitored, such as through a sensory system.

At 625, the milk may be heated and allowed to curdle. In some implementations, different types of milk mixtures may take different lengths of time to curdle. Once the milk has been inoculated and curdled, at 635, cultures may be added to the curdled milk. In some aspects, different types of culture may be added to the curds, such as based on desired taste, texture, and cheese type.

In some aspects, two primary classes of cultures may be considered, thermophilic and mesophilic. In some embodiments, thermophilic cultures may be preferable, such as where the end product must be vegan. Thermophilic cultures may ferment the milk at higher temperatures than mesophilic cultures, which may allow for a reduced risk of contamination. As non-limiting examples, thermophilic cultures may include S. thermophilus and L. acidophilus bacteria. In contrast to a thermophilic culture, mesophilic cultures ferment at room temperature, which may limit the risk of damage to the milk proteins due to extended exposure to high temperatures. As non-limiting examples, mesophilic cultures may include Lactococcus lactis subspecies lactis or cremoris. In some implementations, the mesophilic cultures may be used to create different flavor profiles and cheeses.

In some implementations, cultures may be mixed for optimal fermentation. In some aspects, cultures may be selected based on the molecular composition of the milk type, such as between a hemp seed milk and a chia seed milk. For example, hemp milk may comprise enough carbohydrates for lactobacillus bacteria to ferment into lactic acid. In some embodiments, the target pH level may be based on the bacteria types or milk type, as non-limiting examples.

Once the culture has been added, at 640, the mixture may ferment at the required temperature. In some aspects, the temperature required to ferment may vary based on the type of culture and mixture added to the curdled milk beforehand. After the mixture has fermented, at 645, the non-dairy whey may be drained from the mixture to create the cheese 645. In some aspects, the cheese may be drained by hanging bags on a draining table. In some embodiments, the cheese may be hung overnight. In some aspects, the cheese press may speed up the draining process. In some embodiments, industrial machinery may reduce the time required for the draining process by draining large quantities of the cheese simultaneously.

In some implementations, at 650, seasoning may be added to the cheese to create different tastes and textures. In some aspects, the seasoning may comprise a salt to limit growth of microorganisms, which may increase shelf-life of the cheese. In some embodiments, a salt seasoning may continue to dry the curds, which may allow for a firmer or drier cheese.

Once the seasoning has been added, at 655, the cheese may be pressed into the desired shape. In some aspects, the size and shape may depend on cheese type, consumer preferences, or intended uses for the cheese, as non-limiting examples. In some embodiments, the cheese may be formed using an extruder or traditional cheesemaking techniques with perforated molds that are flipped until all the cheese has been drained, as non-limiting examples.

After the cheese has been sized and shaped, at 660, the cheese may be packaged. In some aspects, different packaging may be used for different types, sizes, and shapes of cheeses. For example, single-serve packaging may differ from multi-serving packaging. In some implementations, the cheese may be packaged using a thermoforming machine with vacuum sealing capabilities to maximize shelf-life. This machine may maintain the shape of a wheel or log similar to soft cheese when its packaged. In some aspects, the cheese may be packaged using a piston to fill plastic cups to present the cheese as a dip or cheese spread. In some embodiments, the cheese may be aged to create shreddable cheeses.

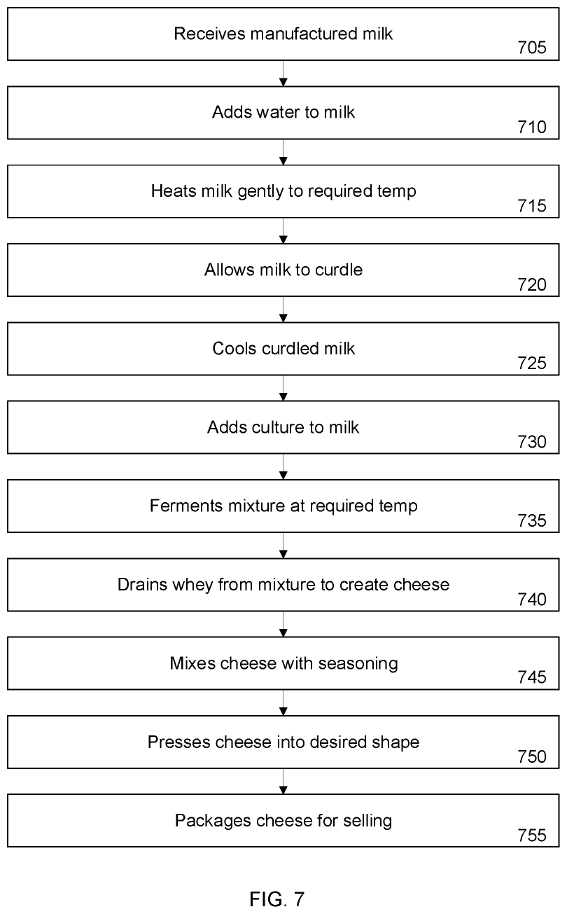

Referring now to FIG. 7, exemplary method steps for producing non-dairy cheese are illustrated. In some aspects, at 705, manufactured milk may be received. In some implementations, the manufactured milk may serve as a base for the cheese culture. In some aspects, the manufactured milk may comprise a plurality of predetermined cultures to reduce the time required for fermentation. Added cultures in manufactured milk may increase the complexity of the taste of the cheese.

In some embodiments, the manufactured milk may be produced at a different facility. For example, a milk manufacturing factory may produce large quantities of milk continuously in industrial-sized vats that are then shipped in totes to the cheese manufacturing facilities. Once the milk is received, at 710, water may be added to the milk.

In some implementations, the manufactured milk may comprise the necessary water. In some embodiments, mixing may need to take place to ensure solids are distributed evenly. In some aspects, the manufactured milk may require filtration. In some embodiments, the milk may be provided optionally with pulp. The pulp may be discarded or removed, and in some aspects, the pulp may then be used for different products. In some aspects, a concentrate of milled or blended hemp hearts may be used, wherein water may be added to create the desired concentration.

Once the milk has been separated, at 715, the milk may be gently heated to the required temperature. In some implementations, the temperature may be manually or automatically monitored, such as through a sensory system. At 720, the milk may be heated and allowed to curdle. In some aspects, different types of milk mixtures may take different lengths of time to curdle. Once the milk has been inoculated and curdled, at 725, cultures may be added to the curdled milk. In some embodiments, different types of culture may be added to the curds, such as based on desired taste, texture, and cheese type.

In some aspects, two primary classes of cultures may be considered, thermophilic and mesophilic. In some embodiments, thermophilic cultures may be preferable, such as where the end product must be vegan. Thermophilic cultures may ferment the milk at higher temperatures than mesophilic cultures, which may allow for a reduced risk of contamination. As non-limiting examples, thermophilic cultures may include S. thermophilus and L. acidophilus bacteria. In contrast to a thermophilic culture, mesophilic cultures ferment at room temperature, which may limit the risk of damage to the milk proteins due to extended exposure to high temperatures. As non-limiting examples, mesophilic cultures may include Lactococcus lactis subspecies lactis or cremoris.

In some implementations, cultures may be mixed for optimal fermentation. In some aspects, cultures may be selected based on the molecular composition of the milk type, such as between a hemp seed milk and a chia seed milk. For example, hemp milk may comprise enough carbohydrates for Lactobacillus bacteria to ferment into lactic acid. In some embodiments, the target pH level may be based on the bacteria types or milk type, as non-limiting examples.

Once the culture has been added, at 735, the mixture may ferment at the required temperature. In some aspects, the temperature required to ferment may vary based on the type of culture and mixture added to the curdled milk beforehand. After the mixture has fermented, at 740, the non-dairy whey may be drained from the mixture to create the cheese 740. In some implementations, at 745, seasoning may be added to the cheese to create different tastes and textures. In some aspects, the seasoning may comprise a salt to limit growth of microorganisms, which may increase shelf-life of the cheese. In some embodiments, a salt seasoning may continue to dry the curds, which may allow for a firmer or drier cheese.

Once the seasoning has been added, at 750, the cheese may be pressed into the desired shape. In some implementations, the size and shape may depend on cheese type, consumer preferences, or intended uses for the cheese, as non-limiting examples. After the cheese has been sized and shaped, at 755, the cheese may be packaged. In some aspects, different packaging may be used for different types, sizes, and shapes of cheeses. For example, single-serve packaging may differ from multi-serving packaging.

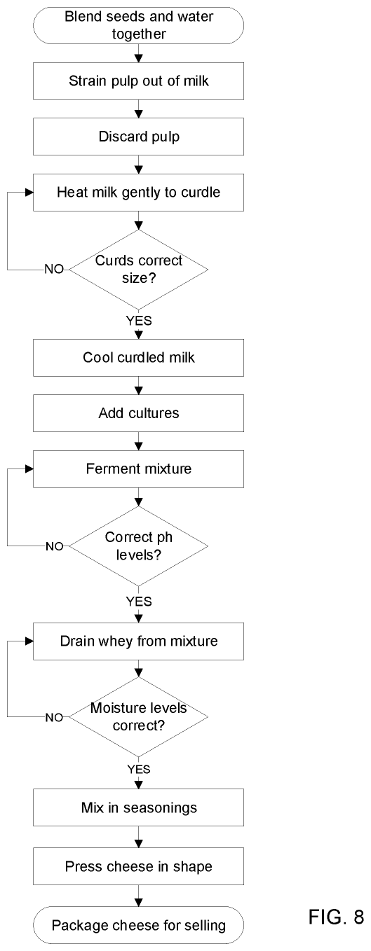

Referring now to FIG. 8, an exemplary flow chart for producing non-dairy cheese is illustrated. In some embodiments, seeds may be blended with water to begin the process. Next the pulp may be strained from the milk so that the two products are separated before the process continues. After the pulp is separated from the milk, the pulp may be discarded or reserved for different products. Once the milk has been separated from the pulp, the milk may be gently heated to curdle. In some aspects, the milk may not curdle to the correct size, and may then need to be reheated or continued to heat so that the curdling process may create milk curds to the correct size. Once the milk has curdled, the milk may cool to a lower temperature before the process can continue.

After the milk has cooled, culture may be added to the milk. Once the culture has been added, then the mixture may ferment. In some aspects, the fermentation process may be monitored to ensure that the pH levels are correct, and if the pH levels fall outside a predefined acceptable range, the process may be adjusted, such as by adding more culture, changing the temperature, or adjusting an amount of mixture.

Once the mixture has been fermented, then the non-dairy whey may be drained from the mixture. In some embodiments, moisture levels may be monitored. In some aspects, the predefined acceptable range for the moisture levels may depend on the type of cheese or desired texture. In some implementations, moisture levels may be adjusted, such as by adding in a fluid like milk or water.

In some implementations, once the non-dairy whey has been drained, the seasonings may be mixed into the cheese for added taste and texture. In some aspects, Additives such as gums, starches, gelling agents, fibers can be added to the cheese to create different textures similar to that of a mozzarella, liquid cheese sauce, goat cheese block, as a non-limiting list of examples. In some implementations, flavoring agents such as nutritional yeast, artificial and natural flavors, other extracts, as non-limiting examples, can be used to enhance flavors to mimic more traditional dairy cheese.

In some embodiments, once the seasonings have been added and the cheese is complete, the cheese may then be pressed into shape. In some implementations, different shapes may be required for different cheeses and portions. After the cheese has been properly shaped, then it may be packaged up for selling. In some aspects, the step of pressing the cheese into a desired shape may occur concurrently with packaging. For example, the cheese may be pressed into a tub, similar to a cream cheese.

In some embodiments, for harder cheeses, once the non-dairy whey is drained, the cheese may be pressed, brined, and aged at a specific temperature and humidity, which may allow the cheese to dry and its flavor may intensify. In some implementations, the cheese may be coated in oil and flipped to ensure no mold grows on the rind. In some aspects, oils may be used to increase mouthfeel or spreadability, as non-limiting attributes, of the cheese.

After a minimum period of time, such as eight months the cheese may be dried enough and the flavor intensified. In some embodiments, different predetermined amounts of drying time may be used to achieve a desired texture such as semi-soft, semi-hard, or hard texture, as non-limiting examples. In some aspects, curds may be pressed multiple times to reduce extra moisture, then milled and salted, before being pressed again and aged. In some embodiments, the exterior of the cheese may be salted and periodically flipped, which may allow for a natural rind. Aging may occur using traditional dry aging techniques, such as through control of humidity levels and temperature, or dehydration, which may reduce aging time. Drying cheese produces a stronger, sharper flavor, which may allow for slicing or grating of the cheese. Different amounts of drying may be preferable to achieve desired texture.

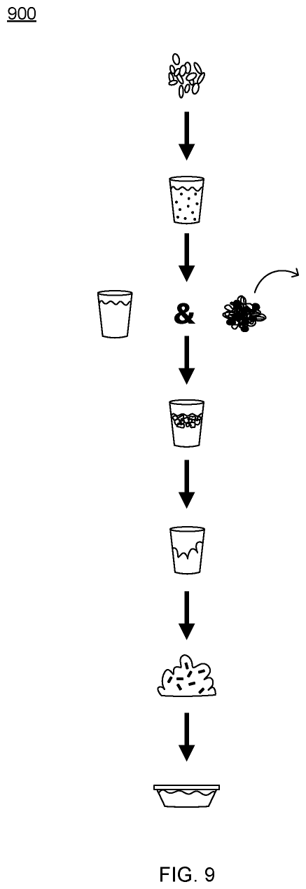

Referring now to FIG. 9, exemplary stages 900 for producing non-dairy cheese are illustrated. In some aspects, the first stage may comprise mixing the seeds with a fluid. The seeds may become pulp and the fluid transformed into milk. Once the seeds have been mixed with the fluid, the milk and pulp may be separated. Once separated, the pulp may be discarded and or reserved for different products. Once the pulp has been removed, the milk may be curdled, such as through heating.

After curdling the milk, culture may be added, and the milk may ferment. Non-dairy whey may be removed from the fermented mix, and the cheese may be prepared and packaged. In some aspects, the fermentation process may vary based on size of mixture, type of culture, and other non-limiting factors.

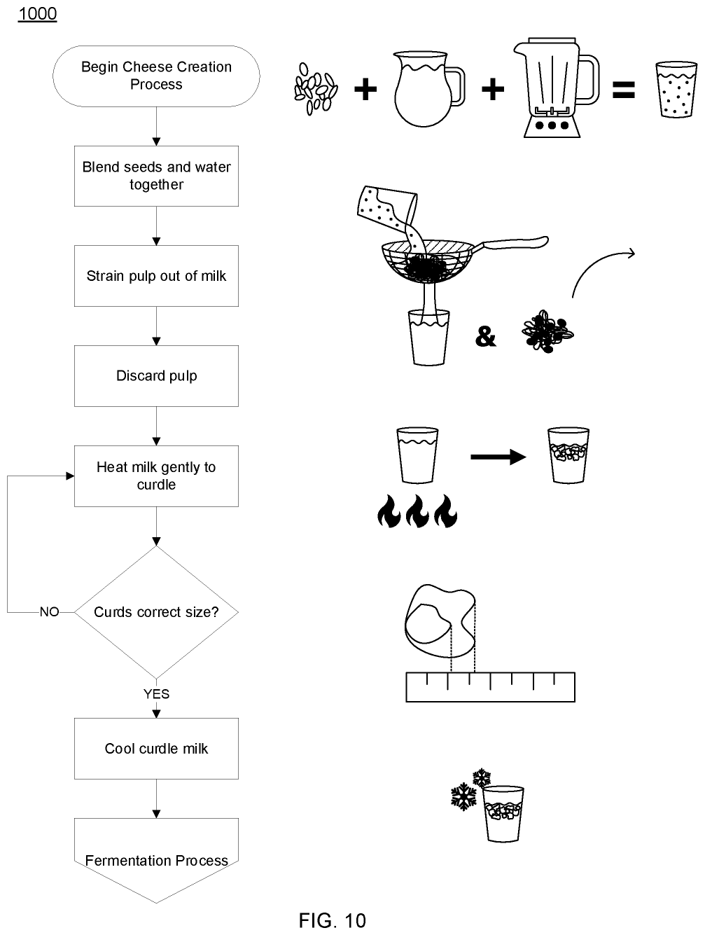

Referring now to FIG. 10, an exemplary flow chart 1000 for producing non-dairy cheese is illustrated. The cheese creation process may begin with the seeds added to a liquid, such as water or milk. Once the seeds have been added to the liquid, then the mixture may be blended together to uniformly mix seed pulp and the liquid. Once blended, the pulp may be strained out of the milk, and the pulp may be discarded or reserved from the mixture for separate use or products. Once the pulp is discarded, the milk may be gently heated to a curdle.

In some aspects, curd size may be monitored, wherein the curdling and cutting process may continue until the curds are within a predefined size range. Once the curds have been measured and the process is complete, the curdled milk may be cooled. Once cooled, the curdled milk may proceed to fermentation.

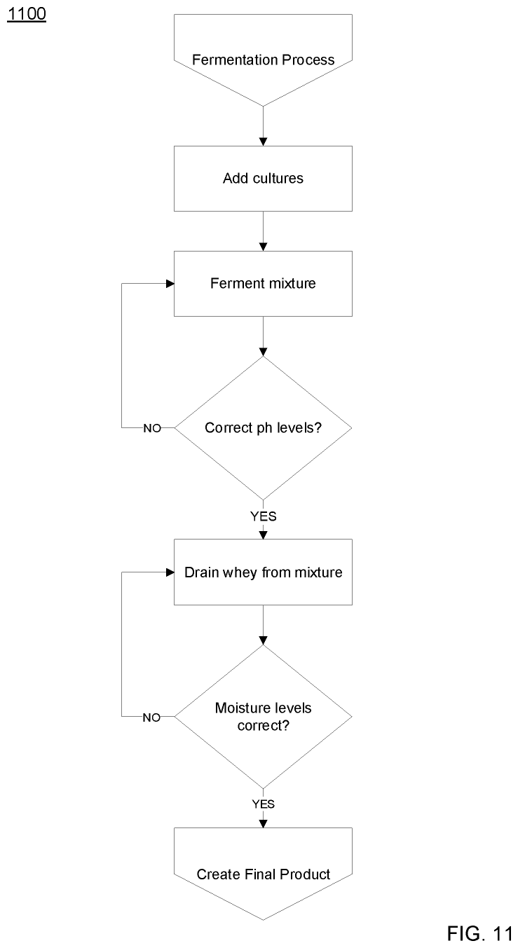

Referring now to FIG. 11, an exemplary flow chart 1100 for producing non-dairy cheese is illustrated. In some embodiments, cultures may be added to the curdled milk. Once the culture has been added, the mixture may begin fermenting. In some implementations, during the fermentation process, the pH levels may be monitored to ensure a consistent product output from the fermentation process.

In some aspects, the pH levels may need to be adjusted throughout the fermentation process, such as by adjusting culture levels, adding different culture, adjusting the amount of curdled milk, adjusting temperature, or adjusting moisture levels, as non-limiting examples. Once the mixture is fermented, then the non-dairy whey may be drained from the mixture. In some aspects, the moisture level may be monitored throughout the process. In some implementations, the moisture levels may be adjusted to maintain an acceptable range. Once the non-dairy whey has been drained, the cheese may be prepared and packaged for shipping or consumption.

In some embodiments, the catabolism of free amino acids, fatty acids, lactic acids and the metabolism of citrate produce volatile aroma compounds. These compounds may consist of esters, ketones, alcohols, aldehydes, hydrocarbons, and sulfur compounds, among others. These compounds may be responsible for the organoleptic quality of cheese. In some aspects, different strains of bacteria may be combined or selected to create flavor compounds. For example, Lactococcus lactis subsp. lactis and Lactococcus lactis subsp. cremoris may be used in acid production, and Lactococcus lactis subsp. biovar diacetylactis and Leuconostoc mesenteidess subsp. cremoris may create lactic acid but also diacetyl (buttery flavor) and CO2 (creation of eyes or holes in swiss cheese). Streptococcus thermophilus may be used in low fat cheese to produce exopolysaccharide, responsible for texture and less bitter flavor than Lc. lactis.

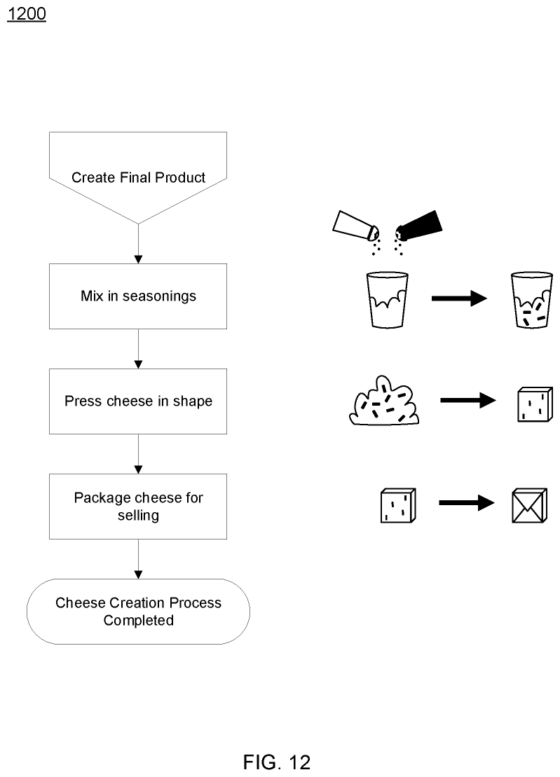

Referring now to FIG. 12, an exemplary flow chart 1200 for producing non-dairy cheese is illustrated. In some embodiments, the fermented mixture may be mixed with seasonings to give the product different tastes and textures. In some aspects, different seasonings may be used for different mixtures or desired results. In some implementations, additional fats such as coconut cream may be added for a desired mouthfeel. Once the seasonings have been added and mixed in, the cheese may be pressed into shape. In some aspects, the shape of the cheese may vary based on many non-limiting factors, such as type of cheese, size of order, shipping requirements, or shelf-life. Once the cheese has been shaped, the cheese may be packaged and prepared for shipping. In some embodiments, the packaging may vary on size shape and order. Once the cheese is packaged and ready to sell, the process may be complete.

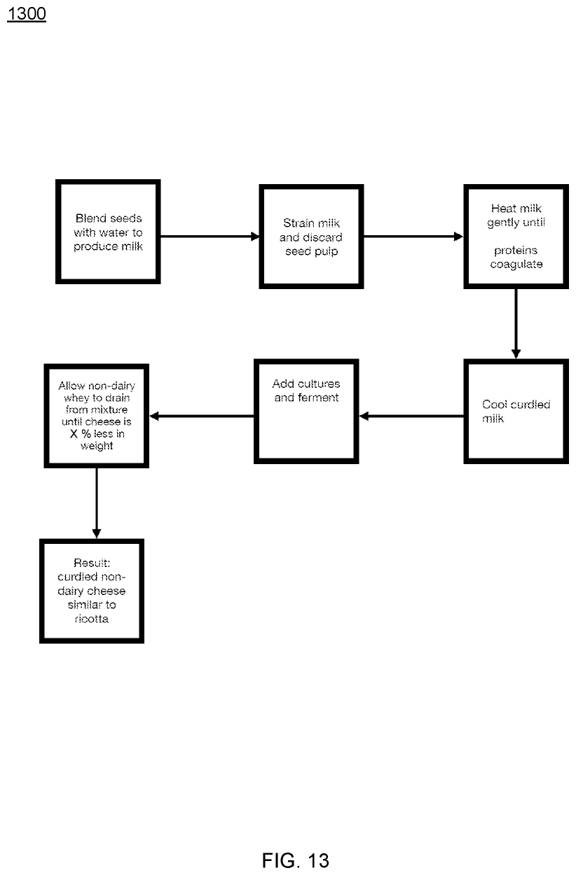

Referring now to FIG. 13, an exemplary flow chart 1300 for producing non-dairy cheese is illustrated. In some aspects, the process may start with the seeds being blended with water or other fluid to produce a milk mixture. After the seeds and liquid have been blended, the milk may be strained, and the seedy pulp may be discarded or reserved. Once the milk has been strained and isolated, the milk may be gently heated to a predefined temperature, allowing proteins to coagulate.

Once milk has been heated, the curdled milk may be cooled to a threshold temperature, which may depend on the cultures used and the type of cheese, as non-limiting examples. The cultures may be added, and the mixture may be fermented within a predefined temperature range for a preset amount of time. The non-dairy whey may be drained from the mixture until the cheese is reduced in weight to an acceptable threshold. As an illustrative, the mixture may be reduced by thirty percent, and the resulting cheese may comprise a texture similar to ricotta or chevre.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single manufacturing system.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method for processing non-dairy cheese, the method comprising:
adding water to a seed-based milk;
heating the seed-based milk to a predefined curdling temperature;
curdling the seed-based milk;
cooling the seed-based milk to a predefined cooling temperature;
creating a mixture by adding at least one culture to the seed-based milk;
fermenting the mixture at a predefined fermenting temperature;
draining non-dairy whey from the mixture; and
removing a cheese from the mixture.

2. The method of claim 1, wherein the seed-based milk comprises a manufactured milk.

3. The method of claim 1, further comprising creating the seed-based milk.

4. The method of claim 3, wherein creating the seed-based milk further comprises:
blending seeds and water; and
straining pulp from the seed-based milk.

5. The method of claim 4, wherein the pulp is used for other products.

6. The method of claim 1, wherein the at least one culture comprises a plurality of culture types.

7. The method of claim 1, further comprising measuring curdle size, wherein curdling occurs until curdles comprise a predefined size.

8. The method of claim 1, wherein the seed-based milk is based on a hemp seed.

9. The method of claim 8, wherein the at least one culture comprises Lactobacillus sp.

10. The method of claim 1, further comprising testing pH levels of the mixture after fermenting, wherein fermenting occurs until a predefined pH level is reached.

11. The method of claim 1, further comprising measuring moisture levels, wherein non-dairy whey is drained until the mixture reaches a predefined moisture level.

12. The method of claim 1, wherein non-dairy whey is removed until the cheese reaches a predefined percentage reduction in weight.

13. The method of claim 12, wherein the predefined percentage reduction in weight comprises at least 30%.

14. The method of claim 1, further comprising adding at least one culture to allow for fermenting.

15. The method of claim 14, wherein the at least one culture comprises a mesophilic bacteria.

16. The method of claim 15, wherein the predefined cooling temperature comprises 40° C. or less.

17. The method of claim 1, wherein the seed-based milk utilizes whole seeds.

18. The method of claim 1, wherein the seed-based milk is utilizes hearts of seeds.

19. A system for processing non-dairy cheese, the system comprising:
a blender configured to receive and blend seeds and water, wherein blended seeds and water initiates seed-based milk with pulp;
a centrifuge configured to separate pulp from the seed-based; and
a cheese vat configured to receive the seed-based milk, wherein the seed-based milk is convertible into cheese within the cheese vat; and
an extruder configured to portion cheese and press into a predefined shape.

20. The system of claim 19, wherein the seeds comprise hemp seeds.
